(19) United States
(12) Patent Application Publication
(10) Pub. No.: US 2003/0160451 A1
(43) Pub. Date: Aug. 28, 2003

(54) Cartridge for fixing collector

(76) Inventor: Choe Min-Cheol, Incheon (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/082,097

(22) Filed: Feb. 26, 2002

(51) Int. Cl. F16L 17/00

(52) U.S. Cl. 285/358

(57) ABSTRACT

A cartridge for fixing a collector includes a main body 100, a cap 200 fixed to the main body 100, and a metallic hook 300 inserted and fixed between the main body 100 and the cap 200 when the cap 200 is adhered to the main body 100 by high frequency waves, in which the metallic hook 300 consists of a hook body 310, inclined elastic flaps 320 sloped arranged around the hook body 310 side by side, and horizontal elastic flaps 330 three to four of which are formed between the inclined elastic flaps 320 around the hook body 310, so that the inclined elastic flaps may expand to hold an external device as the external device expands, while the parallel elastic flaps may securely fix the external device to prevent the cartridge from deviating from the external device while high temperature, high pressure or vibration is exerted to the external device.

### FIELD OF THE INVENTION

The present invention relates to a cartridge for fixing a collector, and more particularly to a cartridge for fixing a collector in which a hook inserted and fixed between a main body and a cap during the adhesion process by high frequency waves having elastic flaps and horizontal elastic flaps together so that the inclined elastic flaps may expand to hold an external device as the external device expands and the parallel elastic flaps may securely fix the external device to prevent the cartridge from deviating from the external device while high temperature, high pressure or vibration is exerted to the external device.

### BACKGROUND OF THE INVENTION

Generally, a cartridge for connecting pipes is applied to a body of an external device, which is difficult to execute one-touch fitting, like a pipe of a water purifier or an inlet or an outlet connected to a chemical-delivery pipe. Such a cartridge has a collector, which is inserted into the cartridge to fix a tube and a copper pipe. The collector is fixed to inside of the external device.

As shown in FIGS. 1 and 2, such a cartridge A has a toothed hook 10 for seizing the external device at a certain outer position and an inclined hook 20 at an inner position to which a collector B is inserted and caught. The collector B inserted and hooked in the cartridge A to connect a delivery pipe such as a tube and a copper pipe has elastic fans 30 so that the collector B may be inserted and then hooked in the inner inclined hook 20 of the cartridge A. The collector B also has reversed hooking flaps 40 inside of the elastic fans 30 so that the delivery pipe is inserted and then hooked therein when a user draws the delivery pipe outwards. Considering the manufacturing process of the cartridge A, which makes the collector B be hooked to the external device C by one touch, the cartridge A is generally made of brass and the toothed hook 10 of the cartridge A is worked in advance.

Such a conventional toothed hook 9 of the cartridge A may prevent the cartridge A from deviating from the external device to some degrees so that the collector may be inserted and fixed to the external device. However, when the external device expands due to heat caused by high pressure or vibrates, the toothed hook 10 does not cope with such conditions. So, there is still a problem that the cartridge A can be deviated from the external device C when the external device is heated or vibrated.

### SUMMARY OF THE INVENTION

The present invention is designed to overcome such a problem of the prior art, and an object of the invention is to provide a cartridge for fixing a collector, in which a hook inserted and fixed between a main body and a cap during the adhesion process by high frequency waves is made of inclined elastic flaps and horizontal elastic flaps, so that the inclined elastic flaps may expand to hold an external device as the external device expands and the parallel elastic flaps may securely fix the external device to prevent the cartridge from deviating from the external device while high temperature, high pressure or vibration is exerted to the external device.

In order to obtain the above object, the present invention provides a cartridge for fixing a collector, which includes a main body, a cap fixed to the main body, and a metallic hook inserted and fixed between the main body and the cap when the cap is adhered to the main body by high frequency waves, in which the metallic hook includes a hook body, inclined elastic flaps sloped arranged around the hook body side by side, and horizontal elastic flaps three to four of which are formed between the inclined elastic flaps around the hook body.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a sectional view showing a cartridge assembled to an external device according to the conventional art:

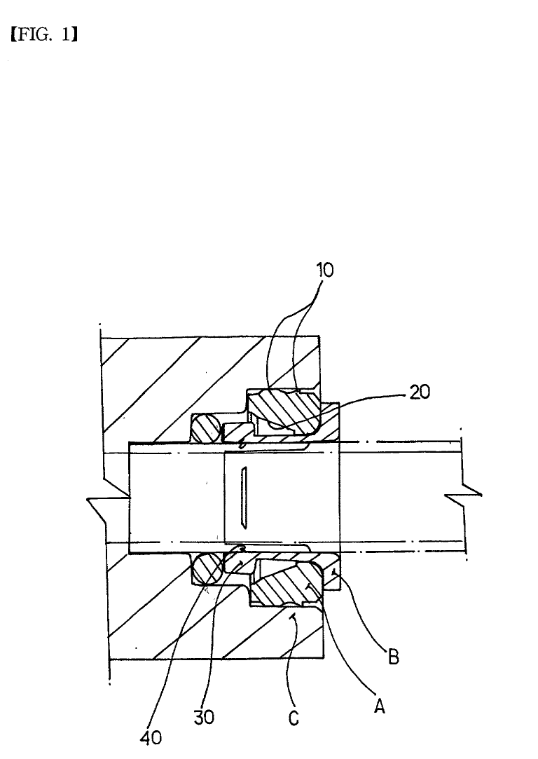

FIG. 2 is a perspective view showing a collect applied to the conventional cartridge:

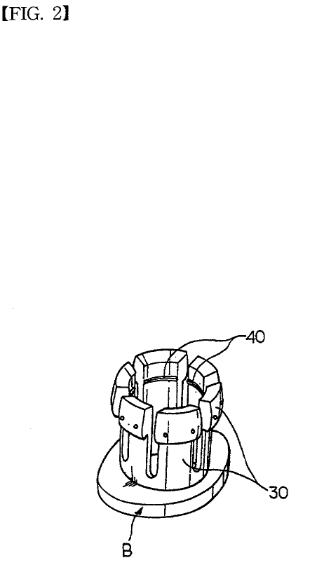

FIG. 3 is an exploded perspective view showing a cartridge according to the present invention;

FIG. 4 is a sectional view showing the assembled cartridge according to the present invention; and

FIG. 5 is a sectional view showing the cartridge applied to an external device according to the present invention.

### DETAILED DESCRIPTION OF THE EMBODIMENTS

Hereinafter, preferred embodiments of the present invention will be described in detail with reference to the accompanying drawings.

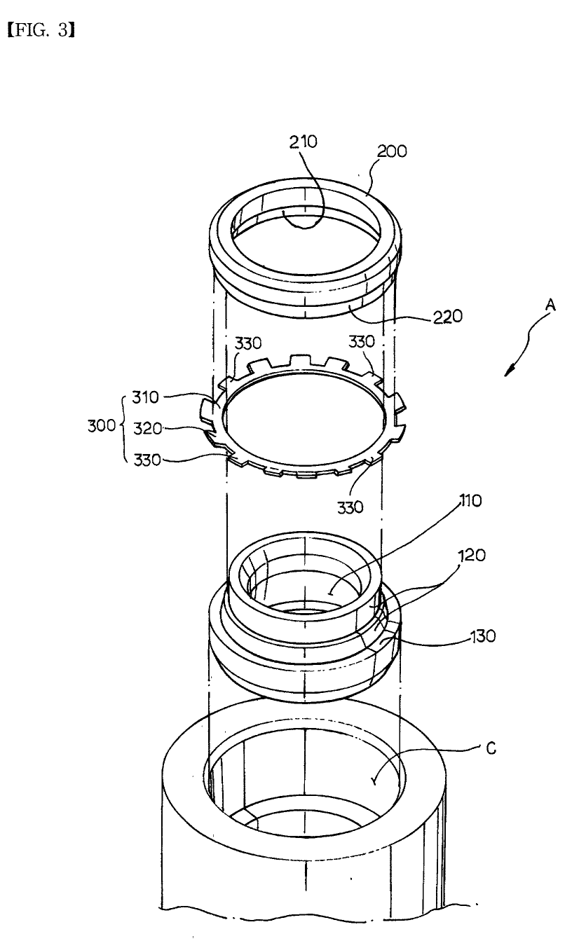

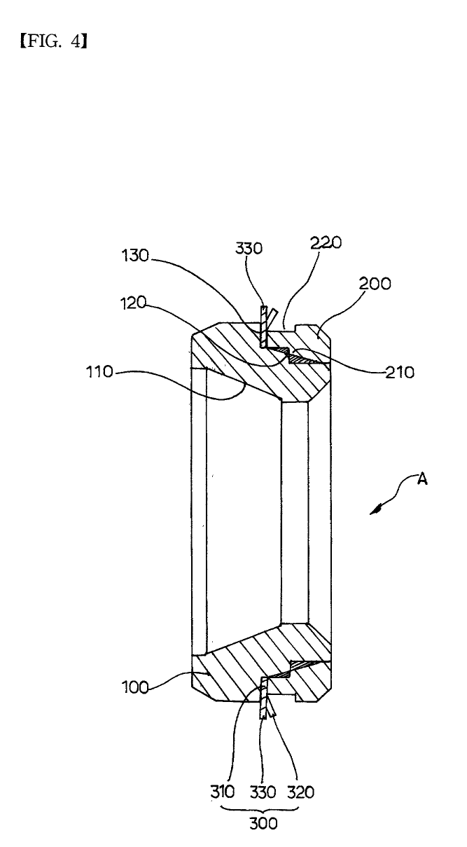

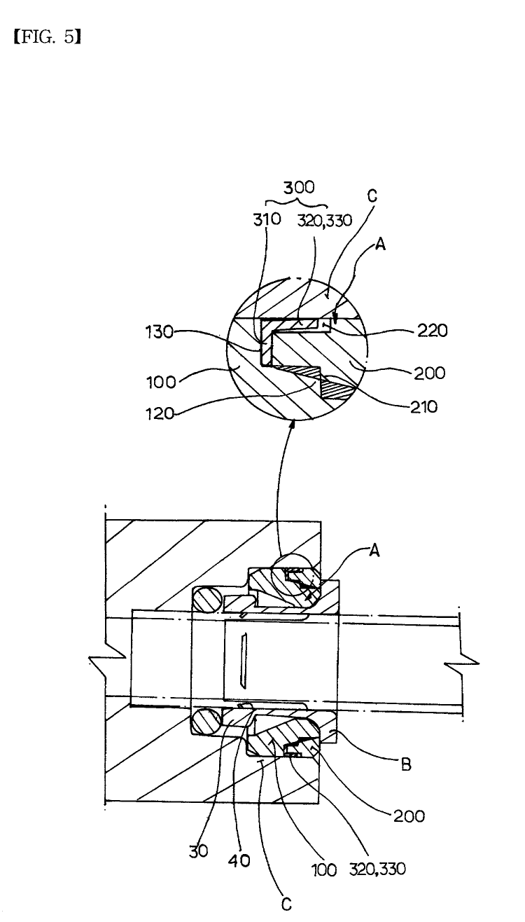

FIG. 3 is an exploded perspective view of a cartridge according to the present invention, FIG. 4 is a sectional view showing an assembled state of the cartridge of the present invention, and FIG. 5 shows that the cartridge of the present is applied to an external device.

As shown in FIGS. 3 to 5, the cartridge A of the present invention includes a main body 100 and a cap 200 fixed to the main body 100. The cartridge A also includes a metallic hook 300 positioned between the main body 100 and the cap 200. The metallic hook 300 is inserted and fixed between the main body 100 and the cap 200 when the main body 100 and the cap 200 are adhered by the use of high frequency waves. The hook 300 substantially consists of a hook body 310 and inclined elastic flaps 320 arranged outside of the hook body 310 side by side, and 3 to 4 horizontal elastic flaps 330 arranged between the inclined elastic flaps 320.

The cartridge A constructed as above is now explained in more detail. The main body 100 of the cartridge A includes, at one side, an inner protrusion 110 having an inclined inner circumference into which the collector B receiving a delivery pipe and to be reversely hooked is elastically inserted. That portion of the main body 100 has an outer circumference to be fitted in the external device C. The main body 100 also includes an outer protrusion 130 so that the hook 300 may be inserted and fixed thereto. Further, the main body 100 includes a weld portion 120 having tiered protrusions at an outer surface from the outer protrusion 130 to the other side.

The cartridge A also includes the cap 200, which has a weld portion 210 at an inner surface to be adhered to the tiered weld portion 120 by the use of high frequency waves and an escape groove 220 of a certain shape at an outer side of an end portion.

Further, the cartridge A includes the metallic hook 300, which has the hook body 310 inserted and fixed between the escape groove 220 of the cap 200 and the outer protrusion 130 of the main body 100, the inclined elastic flaps 320 and the horizontal elastic flaps 330 of which are formed out of the hook body 310.

Seeing the manufacturing process of the cartridge A, the inclined elastic flaps 320 and the horizontal elastic flaps 330 of the metallic hook 300 acting for seizing the external device are manufactured by the pressing process.

At this time, the hook 300 is made of metal having sufficient elasticity. And, the hook body 310 of the metallic hook 300 gives a flat surface to closely contact with the outer protrusion 130. The inclined elastic flaps 320 and the horizontal elastic flaps 330 are integrally extended from the hook body 310 to form like a toothed wheel. The inclined and horizontal elastic flaps 320, 330 are made by the pressing process to be folded or stretched.

On the other hand, the escape groove 220 has so sufficient length on the cap 200 to escape when the inclined and horizontal elastic flaps 320, 330 are pressed by inserting the metallic hook 300 into the external device C.

The weld portions of the cap 200 and the main body 100 are formed to have tiered protrusions and become integrated after welding. The weld portions can have any shape or position to ensure sufficient adhesion between them using high frequency waves.

Such a cartridge A of the present invention is assembled as follows. At first, the main body 100 is inwardly positioned facing the external device C and the cap 200 is outwardly positioned opposite to the main body 100. The inclined elastic flaps 320 of the hook 300 are inclined toward the escape groove 220 of the cap 200, while the horizontal elastic flaps 330 maintain their horizontal state.

Then, if inserting the cartridge A into the external device C, the inclined and horizontal elastic flaps 320, 330 are elastically pressed toward the escape groove 220 and then the fitting process of the cartridge A is completed. At this time, the inclined elastic flaps 320 are inserted into the external device C with being inclined to a certain angle, which may prevent the inner side of the external device from being scratched. The inclined elastic flaps 320 also are reversely hooked with the external device after being inserted thereinto, so that the fitting force of the external device increase as much as possible. The horizontal elastic flaps 330 are pressed at a horizontal state, so greatly increasing their fixing force toward the external device and preventing deviation of the cartridge A.

After fitting the cartridge, an elastic fan 30 of the collector B is elastically inserted and hooked. And then, a delivery pipe such as a tube or pipe is inserted and fixed by using a reversed hook flap 40 so as to connect the external device C to the delivery pipe.

In such a configuration, though the external device C is expanded due to high temperature or high pressure during transferring fluid to the delivery pipe, the inclined elastic flaps 320 of the cartridge A become also expanded as much as the external device C so that the fitting force of the cartridge A is uniformly maintained. In addition, though the external device C is vibrated, the horizontal elastic flaps 330 exert more effective fixing force than the inclined elastic flaps 320 so that the cartridge A may not be deviated.

As discussed above, in the cartridge of the present invention, the metallic hook inserted and fixed between the main body and the cap during the adhesion process using high frequency waves is made with the inclined elastic flaps and the horizontal elastic flaps, so that the inclined elastic flaps may expand to hold an external device as the external device expands, while the parallel elastic flaps may securely fix the external device to prevent the cartridge from deviating from the external device while high temperature, high pressure or vibration is exerted to the external device.

The cartridge for fixing a collector according to the present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A cartridge for fixing a collector comprising:
a main body (100);
a cap (200) fixed to the main body (100); and
a metallic hook (300) inserted and fixed between the main body (100) and the cap (200) when the cap (200) is adhered to the main body (100) by high frequency waves,
wherein the metallic hook (300) consists of a hook body (310), inclined elastic flaps (320) sloped arranged around the hook body (310) side by side, and horizontal elastic flaps (330) three to four of which are formed between the inclined elastic flaps (320) around the hook body (310).
